(19) United States
(12) Patent Application Publication
(10) Pub. No.: US 2010/0040515 A1
(43) Pub. Date: Feb. 18, 2010

(54) Tri-compartment laundry hamper for receiving and disinfecting a plurality of laundry items

(76) Inventor: Kent Derwyn Lovelace, Los Angeles, CA (US)

Correspondence Address: Elizabeth Waiguchu-Jackson, 1200 G Street, NW, Suite 800, Washington, DC, 20005, US

(21) Appl. No.: 12/228,926

(22) Filed: Aug. 18, 2008

(51) Int. Cl. B01J 19/12; B65D 25/04

(52) U.S. Cl. 422/186.08; 220/524

(57) ABSTRACT

A tri-compartment hamper is provided that is easily installed, removed and stored. The hamper is strong, yet relatively light weight and functions among other things to deodorize laundry, allows quick installation in the proper position with a large compartment for dirty clothes, a smaller compartment with a hanging rack for wet clothes, and a bottom drawer compartment.

### FIELD OF INVENTION

The present invention relates to hamper for laundry and more particularly to tri-compartment hamper with an ozone generator source for bactericidal action. As used herein the term tri-compartment hamper includes a hamper unit comprising three compartments wherein the second compartment includes an ozone generator source. The first compartment includes a grid member allowing in ozone from the second compartment. The bottom drawer compartment includes a grid mesh back wall allowing in ozone from said second compartment.

### BACKGROUND

The use of clothes storage containers is known in prior art. While these storage containers fulfill their respective and particular objectives the need remains for a tri-compartment laundry hamper that is equipped with an ozone generator source for eliminating odor and providing bactericidal action before washing the laundry items.

In the new present invention the tri-compartment hamper enables a user to conveniently sanitize different stacks of laundry wet and or dry simultaneously or at different times. The present invention utilizes ozone for bactericidal action on laundry items.

The present invention described is considered the most practical and preferred embodiments. However, it is understood that the invention is not limited to the disclosed embodiments but is intended to cover various arrangements and modifications by those skilled in the art.

### SUMMARY OF THE INVENTION

An exemplary tri-compartment hamper according to the principles of the present invention includes a hamper with three compartments that can support and deodorize predetermined laundry items using ozone generator source.

According to one aspect of the present invention a second compartment is provided with a hanging rack that may be used to hang and deodorize wet laundry items. The first compartment, larger than the second compartment, may be used to deodorize dry laundry items. The bottom compartment may be used to deodorize shoes and small laundry items.

Many advantages of the invention will become apparent with the following detailed description of the drawings in which:

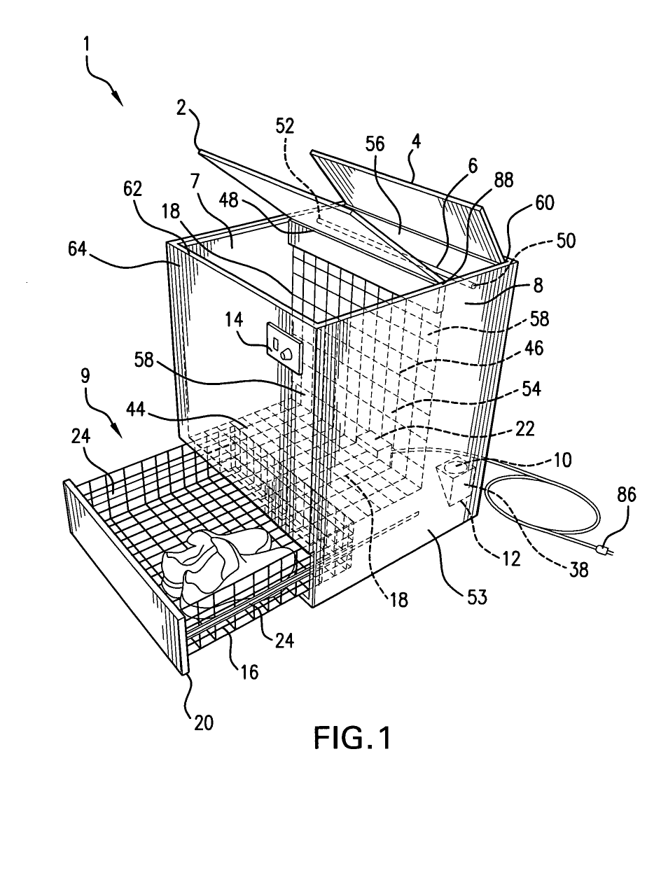

FIG. 1 is a front view of the tri-compartment hamper utilizing ozone generator source.

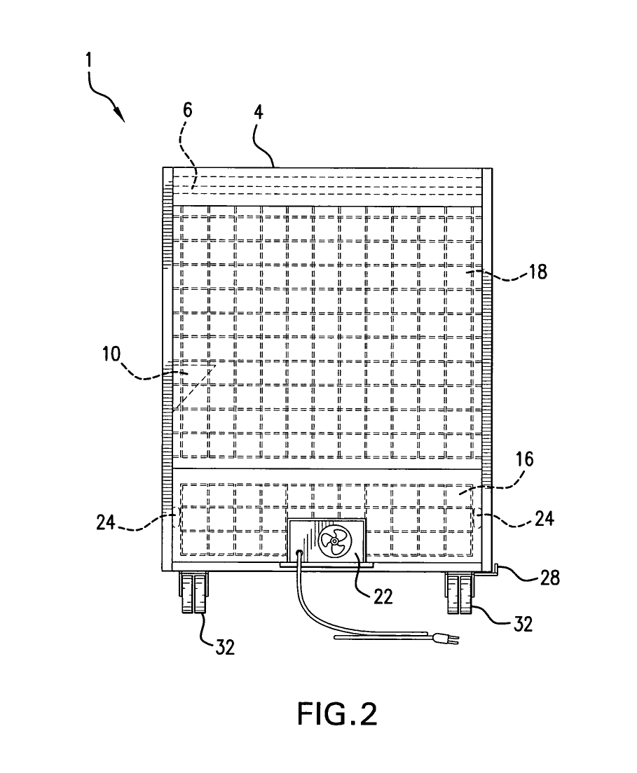

FIG. 2 is a rear perspective view of the tri-compartment hamper.

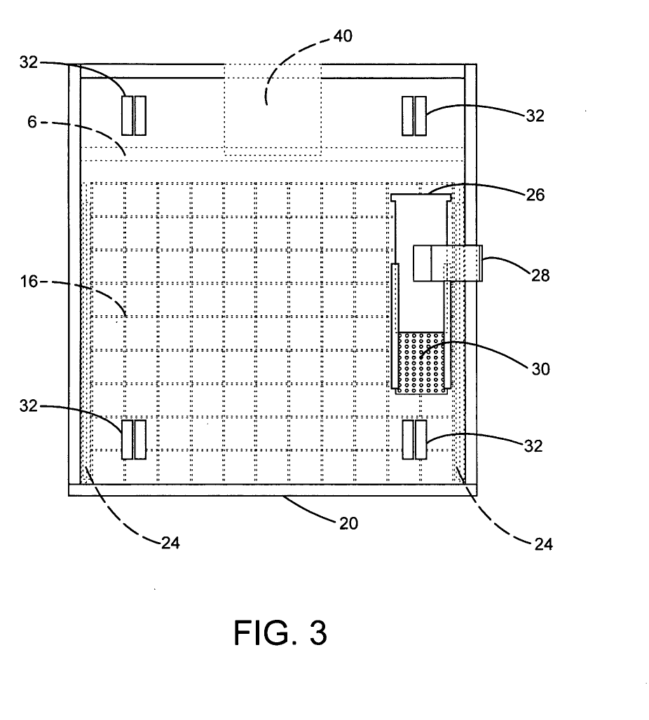

FIG. 3 is a bottom view of the tri-compartment hamper.

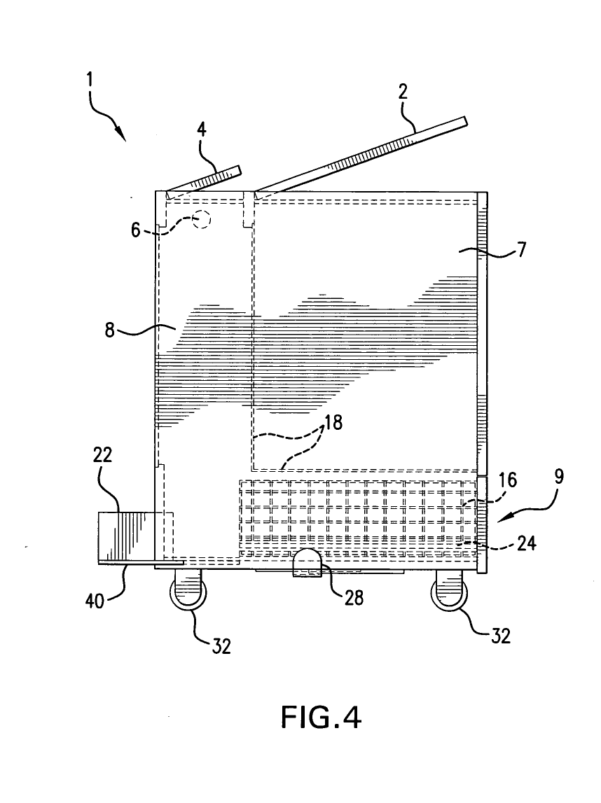

FIG. 4 is a side view of the tri-compartment hamper.

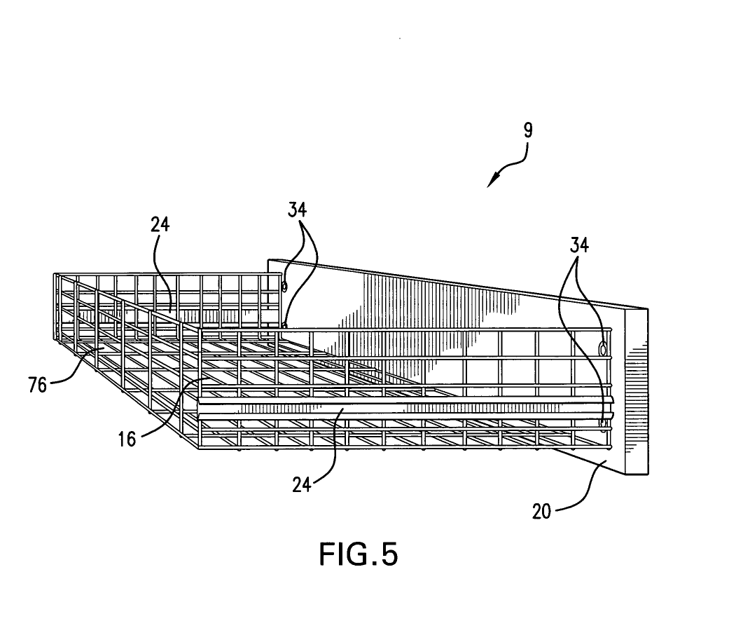

FIG. 5 is a perspective view of the bottom shoe compartment.

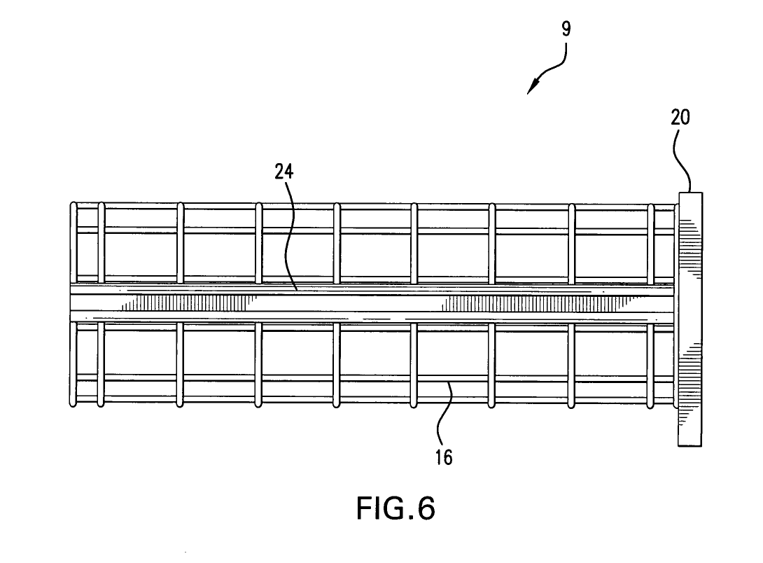

FIG. 6 is a side view of the bottom shoe compartment.

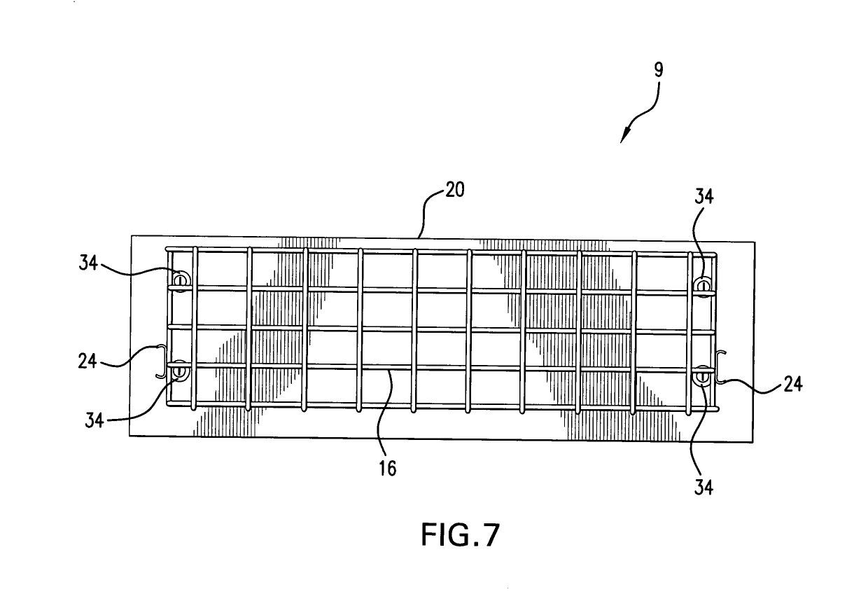

FIG. 7 is a rear view of the bottom shoe compartment.

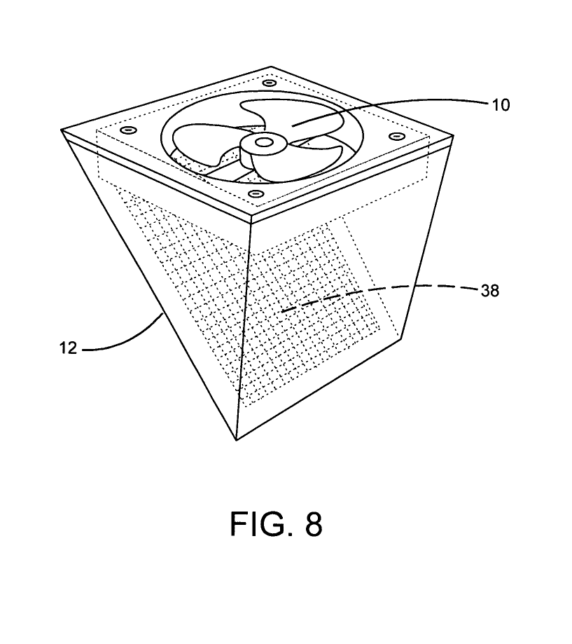

FIG. 8 is a perspective view of the circulating fan for the second compartment.

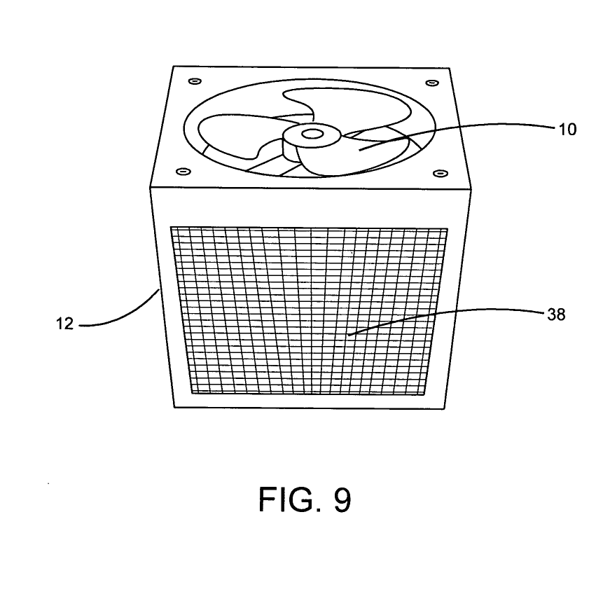

FIG. 9 is a side view of the circulating fan.

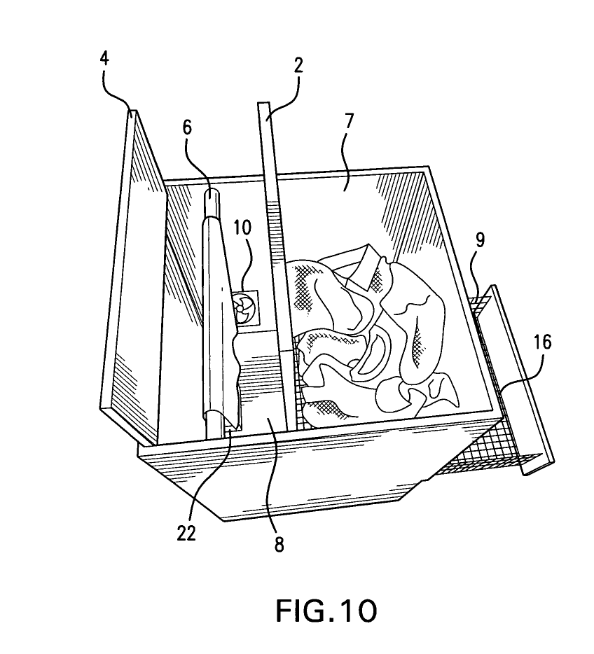

FIG. 10 is top perspective view of the hamper.

### DESCRIPTION OF THE PREFERRED EMBODIMENT

With reference now to FIGS. 1-10, a new tri-compartment laundry hamper embodying the principles and concepts of the present invention and generally designated by the reference numeral 1 will be described.

FIG. 1 shows the tri-compartment laundry hamper comprising three compartments 7,8,9. The first compartment 7 includes a grid mesh member 18 forming the bottom wall 44 and a grid mesh member 18 forming the back wall 46 of the compartment 7. The grid mesh member 18 allows a combination of air and ozone to circulate. The back wall 46 of the first compartment 7 is attached to and extends upwardly from the bottom wall 44. The back wall 46 has an upper edge 48 defining the attachment for first closure lid 2 for opening and closing the first compartment 7. The hamper 1 has a height generally between 1 foot and 5 feet. The ozone generator source control 14 switches to selectively turn on and off the ozone generator source and regulate ozone saturation inside the hamper 1. The ozone generator control 14 is attached to the outside front wall of the first compartment 7. The second compartment 8 includes a hanging rack 6 for hanging wet clothes inside the compartment 8. The hanging rack 6 is a round horizontal bar attached from one side 50 of the hamper 1 to a second side 52 of the hamper 1. The hanging rack 6 is inside the second compartment 8. The second compartment 8 includes a fan 10 with a circulating fan enclosure 12. The ozone generator source 22 in the second compartment 8 is attached to the rear 54 wall and bottom wall 53 of the second compartment 8. The rear wall 54 of the second compartment 8 is adjacent to a side wall 56 of the second compartment 8. The rear wall 54 is parallel to the back wall 58 of the first compartment 7. The rear wall 54 has an upper edge 60 defining an attachment for the second compartment closure lid 4. The second compartment closure lid 4 when in closed position seals the opening for second compartment 8 by secure attachment to the upper edge 88 of the rear wall 54 of the second compartment 8. The closure lid 2 for the first compartment 7 when in closed position securely seals the opening for the first compartment 7 by attachment to the upper edge 62 of the front wall 64.

The bottom compartment 9 has a rigid grid mesh member 16 at the base of the compartment 9. The bottom compartment 9 is moved to an open position by pulling out the drawer 20. The bottom compartment 9 has an open back which allows a combination of ozone and air from the second compartment 8 to flow into the bottom compartment 9.

When the lids 2,4 are closed, the ozone generator control 14 selectively turned on and the hamper 1 plugged to an electricity source 86, the ozone generator source 22 in the second compartment 8 produces ozone combined with air. The fan 10 circulates a combination of air and ozone into compartments 7,8 and 9.

FIG. 2 is a rear perspective view of the tri-compartment hamper 1 with a grid mesh member 18, the ozone generator source 22 and the circulating fan 10. The circulating fan 10 is capable of circulating a combination of ozone and air in the compartment 8 and into compartments 7,9. The hamper 1 includes an ozone exhaust vent 28. When the ozone exhaust vent 28 is open, the ozone from the hamper is capable of deodorizing air outside. Clothes hanging on the rack 6 are capable of being exposed to ozone and air from the ozone generator 22. The hamper 1 further includes four swivel caster wheels 32 to move the hamper 1 to a desired position.

FIG. 3 is the bottom view of the tri-compartment hamper 1. The hamper 1 includes an ozone exhaust vent 30, an ozone exhaust vent door 26, and an ozone exhaust vent handle 28. The hamper 1, includes 2 pairs of swivel caster wheels 32 at the bottom of the hamper 1. Access for placing shoes and other items into the bottom compartment 9 may be obtained by moving the drawer 20 along the drawer glides 24. The bottom compartment 9 includes a rigid grid mesh member 16. The ozone generator source includes a platform 40 wherein the platform 40 is capable of sliding out to allow access.

FIG. 4 is a side view of the tri-compartment hamper 1. The ozone generator source 22 on the platform 40 at the rear of the second compartment 8 can be accessed for maintenance by moving the platform 40. The grid mesh members 18,16 allow bactericidal ozone into the compartments 7,9,8 when the lids 4,2 are in closed positions, the ozone generator source 22 is turned on and the hamper 1 is plugged to a means for electrical source.

FIG. 5 is a perspective view of the bottom compartment 9. The compartment 9 has an open back 76 comprising of a grid mesh member 16. The compartment 9 also has drawer glides 24, shoe drawer front 20, and shoe drawer attaching screws 34.

FIG. 6 is a side view of the bottom compartment 9. The grid mesh member 16, the drawer front 20 and drawer glides 24 are attached to the compartment 9.

FIG. 7 is a rear view of the bottom compartment 9 showing attaching screws 34, the drawer front 20, the grid mesh member 16 and the drawer glides 24.

FIG. 8 is a perspective view of the circulating fan 10 in the compartment 8 showing the circulating fan enclosure 10 and circulating fan intake opening 38.

FIG. 9 is a front view of the circulating fan 10 showing the circulating fan enclosure 10 and the circulating fan intake opening 38.

FIG. 10 is top perspective view of the hamper 1 with clothes inside compartments 7 and 8. The ozone generator source 22, the circulating fan 10, the hanging clothes rack 6 are inside the second compartment 8. The second compartment 8 includes a top lid 4. The first compartment 7 includes a top lid 2. The bottom drawer compartment 9 has a rigid grid mesh member 16.

What is claimed is:

1. A tri-compartment laundry hamper for receiving and disinfecting a plurality of laundry items comprising:
a container including a first compartment, a second compartment with a hanging rack, and a third bottom shoe compartment,
an ozone generator source attached to said container for generating ozone,
a movable platform for storing said ozone generator source inside said container,
an electrical connection means for said hamper,
a plurality of fans inside said hamper,
a plurality of grid mesh members attached to said hamper,
a ventilation means for said hamper,
a plurality of closure lids.

2. The tri-compartment laundry hamper of claim 1, said container comprising:
a rectangular shaped horizontally disposed bottom panel, a first vertical member, a second vertical member, a third vertical member and a fourth vertical member.

3. The tri-compartment laundry hamper of claim 2, said container further comprising:
said first vertical member and said second vertical member, each extending upwardly at 90 degree angle from adjacent sides of said rectangular shaped bottom panel.

4. The tri-compartment laundry hamper of claim 3, said container comprising:
a third vertical member extending upwardly at 90 degree angle from said bottom panel,
said third vertical member extending parallel to said first member and,
said third vertical member and said first member attached to said bottom panel at opposing side of said bottom panel.

5. The tri-compartment laundry hamper of claim 4, said container comprising:
a fourth vertical member extending upwardly at 90 degree angle from said bottom panel,
said fourth vertical member extending parallel to said second vertical member and,
said fourth vertical member and said second member attached to said bottom panel at opposing sides of said bottom panel.

6. The tri-compartment laundry hamper of claim 5, said container further comprising:
said first vertical member fixedly attached to said second vertical member and said fourth member at opposing edges of said first vertical member,
said second vertical member fixedly attached said third vertical member and the first vertical member at opposing edges of said second side panel, and,
said third vertical member fixedly attached to said vertical second member and said fourth vertical member at the opposing edges of said third vertical member.

7. The tri-compartment laundry hamper of claim 1, wherein said container comprises:
a first compartment with said grid mesh member,
a second compartment with a hanging rack, and,
a third bottom drawer compartment with said grid mesh member wherein said grid mesh member is rigid.

8. The tri-compartment laundry hamper of claim 7, further comprising:
a first top closure lid for said first compartment wherein said closure lid is capable of opening and closing said first compartment and,
a second top closure lid for second compartment wherein said closure lid is capable of opening and closing said second compartment.

9. The tri-compartment laundry hamper of claim 8 further comprising:
said first top closure lid pivotally connected to said container at a first upper region of the container, and said first lid capable of securely enclosing said first compartment, and,
said second top closure lid pivotally connected to the container at second upper region of the container, and said second lid capable of securely enclosing said second compartment.

10. The tri-compartment laundry hamper of claim 1, further comprising said bottom compartment connected to said container at a lower region of said container.

11. The tri-compartment laundry hamper of claim 10, further comprising said bottom drawer compartment capable of opening and closing.

12. The tri-compartment laundry hamper of claim 1, further comprising a means for electricity connection to a household electrical plug.

13. The tri-compartment laundry hamper of claim 1, wherein said first compartment further includes an ozone generator source control.

14. The tri-compartment laundry hamper of claim 1, wherein said hamper is made of materials selected from a list comprising wood, cloth, plastic, glass, wire, wicker, ceramic, steel, metal or a combination thereof.

15. The tri-compartment laundry hamper of claim 1, further comprising said fans circulating a combination of ozone and air by movement when said ozone generator source is switched on and said electrical power means is turned on.

16. The tri-compartment laundry hamper of claim 1, comprising:
at least one circulating air fan inside said second compartment,
at least one circulating air fan attached to said ozone generator source and,
at least one an ozone generator source inside said second compartment.

17. The tri-compartment of claim wherein:
said first compartment is capable of receiving combined ozone and air from said second compartment, and
said bottom shoe compartment is capable of receiving combined ozone and air from said second compartment.

18. The tri-compartment laundry hamper of claim 1, comprising said hamper plugged to an electrical source being capable of providing bactericidal combined ozone and air when said ozone generator source is turned on.
